(19) United States
(12) Patent Application Publication
(10) Pub. No.: US 2026/0301006 A1
(43) Pub. Date: Oct. 1, 2026

(54) SCENARIO PLANNING DEVICE, SCENARIO PLANNING METHOD, AND MEDIUM

(71) Applicant: NEC Corporation, Tokyo (JP)

(72) Inventors: Daisuke MATSUDA, Tokyo (JP); Muneyuki HAMABE, Tokyo (JP); Shintaro SOMA, Tokyo (JP)

(73) Assignee: NEC Corporation, Tokyo (JP)

(21) Appl. No.: 19/426,468

(22) Filed: Dec. 19, 2025

(30) Foreign Application Priority Data
Mar. 31, 2025 (JP) 2025-057840

(51) Int. Cl. G06Q 30/0201

(52) U.S. Cl. CPC G06Q 30/02016

(57) ABSTRACT

A scenario planning device according to the present disclosure includes: a memory; and one or more processors coupled to the memory. The memory is configured to store instructions. The one or more processors are configured to execute the instructions stored in the memory. The instructions include to: receive scenario planning target information; generate a scenario plan, based on the scenario planning target information and a first generative model; and generate a scenario content for visualizing the scenario plan, based on the scenario plan and a second generative model. Further, the generated scenario content can be utilized as an AI-based support tool for strategic decision making across various applications.

This application is based upon and claims the benefit of priority from Japanese Patent Application No. 2025-057840, filed on Mar. 31, 2025, the disclosure of which is incorporated herein in its entirety by reference.

### TECHNICAL FIELD

The present invention relates to a scenario planning device, a scenario planning method, and a medium.

### BACKGROUND ART

WO 2023/157149 A1 discloses a device that extracts a subject from associated information such as news and a statistical report based on a selected field, an analysis frame, and the like, and generates time series information in which events for each subject are arranged in time series.

### SUMMARY

A scenario planning device according to an aspect includes a reception unit configured to receive scenario planning target information; a scenario plan generation control unit configured to generate a scenario plan, based on the scenario planning target information and a first generative model; and a scenario content generation control unit configured to generate a scenario content for visualizing the scenario plan, based on the scenario plan and a second generative model.

A scenario planning method according to an aspect causes at least one processor to receive scenario planning target information, generate a scenario plan, based on the scenario planning target information and a first generative model, and generate a scenario content for visualizing the scenario plan, based on the scenario plan and a second generative model.

A scenario planning program according to an aspect causes a computer to function as a reception process of receiving scenario planning target information, a scenario plan generation control process of generating a scenario plan, based on the scenario planning target information and a first generative model, and a scenario content generation control process of generating a scenario content for visualizing the scenario plan, based on the scenario plan and a second generative model.

### BRIEF DESCRIPTION OF THE DRAWINGS

FIG. 1 is a diagram illustrating an example of scenario planning according to the present disclosure;

FIG. 2 is a block diagram illustrating a configuration of a scenario planning device according to the present disclosure;

FIG. 3 is a flowchart showing a flow of a scenario planning method according to the present disclosure;

FIG. 4 illustrates an example of a prompt and an output according to the present disclosure;

FIG. 5 illustrates an example of a prompt and an output according to the present disclosure;

FIG. 6 illustrates an example of a prompt and an output according to the present disclosure;

FIG. 7 illustrates an example of a prompt and an output according to the present disclosure;

FIG. 8 illustrates an example of a prompt and an output according to the present disclosure;

FIG. 9 is a block diagram illustrating the configuration of a scenario planning device according to the present disclosure;

FIG. 10 is a flowchart showing a flow of a scenario planning method according to the present disclosure; and

FIG. 11 is a block diagram illustrating a configuration of a computer that functions as an information processing device according to the present disclosure.

### EXAMPLE EMBODIMENT

Hereinafter, example embodiments of the present invention will be described. However, the present invention is not limited to the example embodiments described below, and various modifications can be made within the scope described in the claims. For example, example embodiments obtained by appropriately combining techniques (some or all of devices or methods) adopted in the following example embodiments can also be included in the scope of the present invention. Example embodiments obtained by appropriately omitting some of the techniques adopted in the following example embodiments can also be included in the scope of the present invention. Effects mentioned in the following example embodiments are examples of effects expected in the example embodiments, and do not define extension of the present invention. In other words, example embodiments that do not provide the effects mentioned in the example embodiments described below can also be included in the scope of the present invention.

### First Example Embodiment

### Overall Configuration

In a first example embodiment, a scenario planning device that generates a content related to a scenario plan will be described.

Scenario planning is a method of considering an effective strategy and measures for each scenario assuming a plurality of uncertain situations (scenarios) that can occur in the future. An object of scenario planning is to assume a plurality of scenarios in consideration of, for example, technological innovation and changes in market trends, and to advance preparation in such a way as to be able to flexibly cope with possible risks and opportunities.

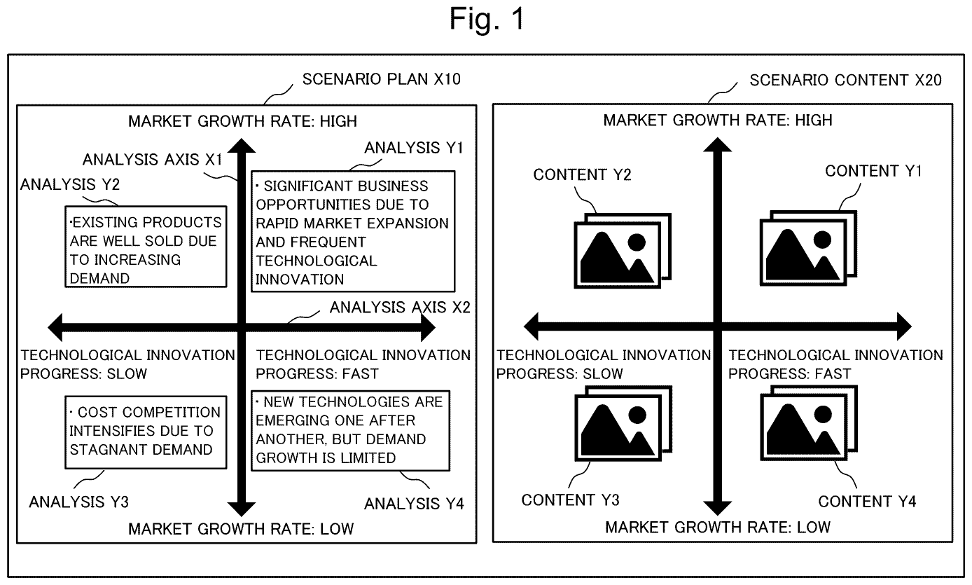

FIG. 1 is a diagram illustrating an example of scenario planning. In one example, scenario planning is performed by combining a scenario plan X10 and a scenario content X20 as illustrated in FIG. 1.

The scenario plan X10 has a configuration in which four scenarios can be assumed by combining a vertical axis (analysis axis X1) representing a market growth rate and a horizontal axis (analysis axis X2) representing the progress of technological innovation. In the four scenarios, analysis Y1 to analysis Y4 regarding an assumed future image in the situation of each scenario are stored. The analysis is performed on, for example, an index serving as an analysis item such as an assumed future image and a main risk, a target organization, and the like. The scenario plan is not limited to the form of a graph as illustrated in FIG. 1, and may be in the form of a text or a table.

Similarly to the scenario plan X10, the scenario content X20 has a configuration in which four scenarios can be assumed by combining a vertical axis (analysis axis X1) representing a market growth rate and a horizontal axis (analysis axis X2) representing the progress of technological innovation. In the four scenarios, a content corresponding to an analysis is stored. For example, the content Y1 is a content evoked from the analysis Y1, and may be an image, a moving image, or the like.

### Functional Configuration

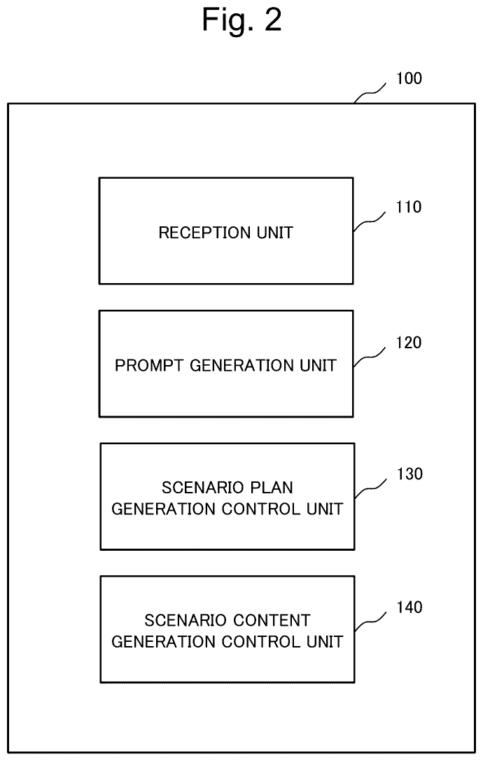

FIG. 2 is a block diagram illustrating a configuration of a scenario planning device 100. The scenario planning device 100 includes a reception unit 110, a prompt generation unit 120, a scenario plan generation control unit 130, and a scenario content generation control unit 140.

The reception unit 110 receives scenario planning target information. The reception unit 110 may receive the scenario planning target information from a storage device. Alternatively, the reception unit 110 may receive the scenario planning target information input via an apparatus used by a user.

The scenario planning target information is information including at least one of basic information (an organization, analysis items, and the like), an analysis axis, and other peripheral information (a market trend, a financial index, or the like) to be subjected to scenario planning.

The basic information indicates basic data regarding an organization, a company, or the like to be subjected to scenario planning. For example, the basic information is information such as a target company outline, a target region, and a target product.

The analysis axis is a criterion used to evaluate a scenario. For example, the analysis axis may be progress of technological innovation, a market growth rate, changes in regulations and laws, a competitive situation, macroeconomic factors, changes in consumer needs and values, geopolitical risks, environmental and climate factors, social and cultural factors, stability of a supply chain, and the like.

The peripheral information is peripheral information of a scenario planning target. Examples thereof include an organization structure (department configuration, position, and organization chart), a financial statement (income statement, balance sheet, cash flow statement), past performance (sales, profit, growth rate), a budget (budget plan and comparison with actual achievement), market share (share within the industry, positioning relative to competitors), a target customer (customer segment, customer needs), a customer satisfaction survey (customer feedback, NPS), a product portfolio (main product, service line-up), a new product plan (progress of product development, schedule of new service), a product life cycle (stage of each product), the number of employees (total number of people, number of people per department), a skill map (professional skills and qualification of each employee), a human resources development program (training program, education system), a technical foundation (currently used technologies, systems), a research and development situation (progress of R & D project and technology development), an intellectual property (patents, trademarks), and the like.

The prompt generation unit 120 generates a prompt based on the scenario plan target information received by the reception unit 110. Specifically, for example, the prompt generation unit 120 generates a prompt by incorporating the scenario plan target information into a predetermined template. The prompt is an instruction statement to be input to a generative model to be described later. For example, the prompt is a sentence in a natural language including the scenario plan target information. The prompt generation unit 120 outputs a prompt based on the scenario plan target information to the scenario plan generation control unit 130.

The scenario plan generation control unit 130 receives a prompt (first prompt) generated by the prompt generation unit 120 as an input, and generates a scenario plan using a machine learning model (first generative model). The machine learning model (first generative model) is any machine learning model, and may be, for example, a large-scale language model, a time-series prediction model, a multimodal model, or the like. For example, in a case where both a prompt to be input and an answer to be output are text data of a natural language, a language model that has learned a natural language may be applied as the generative model. Here, training a natural language more specifically means training an arrangement of components (words and the like) in a sentence in the natural language or an arrangement of a sentence and a sentence in a text. Examples of such a language model include bidirectional encoder representations from transformers (BERT), robustly optimized BERT approach (RoBERTa), efficiently learning an encoder that classifies token replacements accurately (ELECTRA), and the like. The first generative model may be obtained by fine-tuning a general-purpose generative model in such a way that information necessary for generating a scenario plan is generated with high accuracy. In the fine tuning, data including a set of a prompt and an answer to be generated for the prompt may be used as the training data.

The scenario plan generation control unit 130 may be connected to an external database 132. The first generative model may generate scenario planning information with reference to a media content such as newspaper articles, economic and financial data, industry reports, academic papers, social media data, government announcement data, patent information, and market research reports from the external database 132. A search extension generation technique such as retrieval augmented generation (RAG) may be used to refer to the database. Thereby, it is possible to reflect a media content not included in learning data of the generative model or detailed information regarding a specific domain in the answer.

The first generative model may be stored in the scenario planning device 100 or may be stored in another device. In the latter case, the scenario plan generation control unit 130 may transmit a prompt to another device to generate an answer, and acquire the generated answer from the other device.

The scenario content generation control unit 140 generates a scenario content in which a scenario is visualized based on the generated scenario plan. For example, the scenario content includes an image, a moving image, or a combination thereof. The scenario content generation control unit 140 may input the scenario plan to a machine learning model (second generative model) to generate a scenario content. The machine learning model may be a generative adversarial network (GAN) learned to be able to generate images, a variational autoencoder (VAE), a generative model such as a diffusion model and a transformer model. The scenario content generation control unit 140 may input a prompt to the second generative model to generate a scenario content. In this case, the prompt generation unit 120 generates a prompt (second prompt) based on the scenario plan generated by the scenario plan generation control unit 130, and outputs the prompt to the scenario content generation control unit 140.

The second generative model may be stored in the scenario planning device 100 or may be stored in another device. In the latter case, the scenario plan generation control unit 140 may transmit a prompt to another device to generate an answer, and acquire the generated answer from the other device.

As described above, in the scenario planning device 100 according to the first example embodiment, a configuration is adopted in which the reception unit 110 that receives scenario planning target information, the prompt generation unit 120 that generates a prompt based on the scenario planning target information, the scenario plan generation control unit 130 that generates a scenario plan by inputting the prompt to a first generative model that refers to a database including at least data regarding a media content, and the scenario content generation control unit 140 that generates a scenario content by inputting the scenario planning target information to a second generative model.

According to the above configuration, it is possible to obtain an effect that a content related to a scenario plan can be generated.

### Scenario Planning Program

The functions of the scenario planning device 100 described above can also be achieved by a program. A scenario planning program according to the first example embodiment causes a computer to function as reception means for receiving scenario planning target information, prompt generation means for generating a prompt based on the scenario planning target information, scenario plan generation control means for generating a scenario plan by inputting a prompt to a first generative model that refers to a database including at least data regarding a media content, and scenario content generation control means for generating a scenario content by inputting the scenario planning target information to a second generative model. According to this scenario planning program, it is possible to obtain an effect that a content related to a scenario plan can be generated.

### Flow of Scenario Planning Method

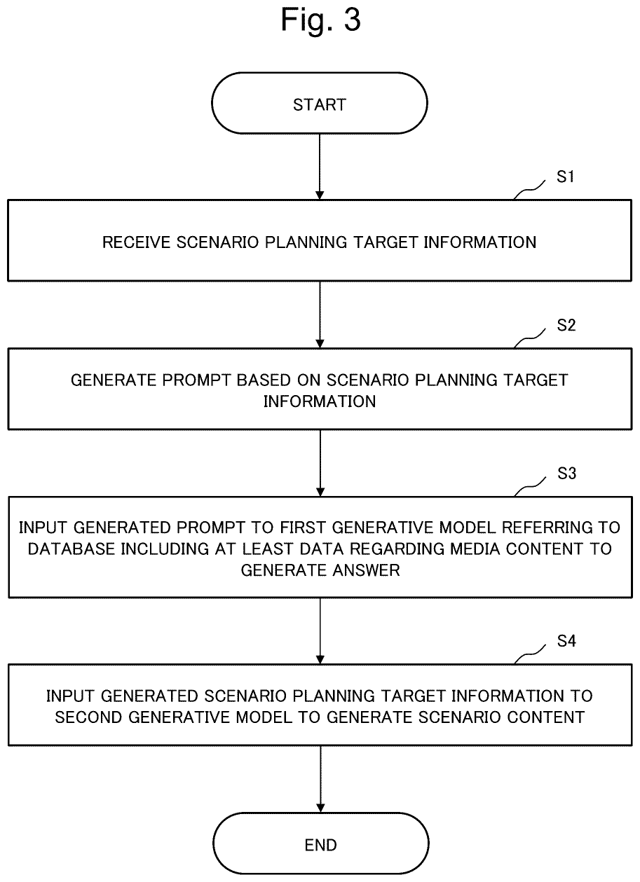

A flow of a scenario planning method according to the first example embodiment will be described with reference to FIG. 3. FIG. 3 is a flowchart showing a flow of a scenario planning method.

In S1 (reception process), at least one processor receives scenario planning target information.

In S2 (prompt generation process), at least one processor generates a prompt based on the scenario planning target information received in S1.

In S3 (scenario plan generation control process), at least one processor inputs the prompt generated in S2 to the first generative model to generate an answer.

In S4 (scenario content generation control process), at least one processor inputs scenario planning information generated in S3 to the second generative model to generate a scenario content.

As described above, a configuration is adopted in which the scenario planning method according to the first example embodiment includes a reception process of receiving scenario planning target information, a prompt generation process of generating a prompt based on the scenario planning target information, a scenario plan generation control process of generating a scenario plan by inputting the prompt to a first generative model that refers to a database including at least data regarding a media content, and a scenario content generation control process of generating a scenario content by inputting the scenario planning target information to a second generative model. For this reason, according to the above configuration, it is possible to obtain an effect that a content related to the scenario plan can be generated.

An execution entity of each processing described in the above first example embodiment is any entity and is not limited to the above-described examples. For example, a system having a function similar to that of the scenario planning device 100 can be constructed by a plurality of devices capable of communicating with each other. An execution subject of each process shown in the flowchart shown in FIG. 3 may be one device (also referred to as a processor) or a plurality of devices (also referred to as a processor).

### Specific Example of Scenario Plan Generation

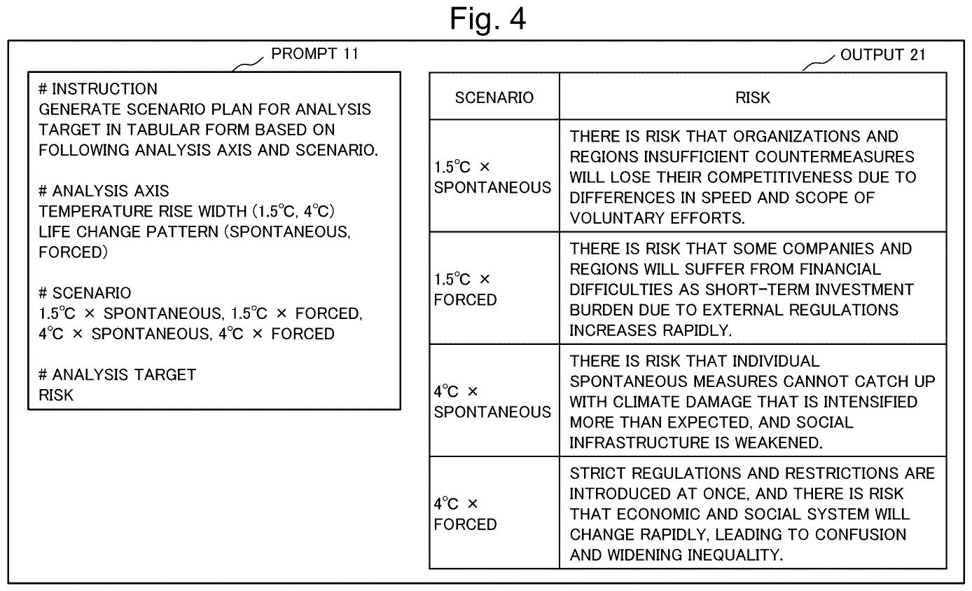

Here, an example of a prompt that is an input of a first model used by the scenario plan generation control unit 130 and a scenario plan that is an output of the first model will be described with reference to FIG. 4. FIG. 4 is a diagram illustrating a prompt 11 that is an input of the first model used by the scenario plan generation control unit 130 and an output 21 that is an output of a first generative model.

As illustrated in FIG. 4, the prompt 11 includes sections of “instruction”, “analysis axis”, “scenario”, and “analysis target”. In the “instruction”, an instruction sentence for generating a scenario plan is described in a natural language. In the “analysis axis”, an analysis axis included in the scenario planning target information received by the reception unit 110 is described. In the example illustrated in FIG. 4, “temperature rise width (1.5° C., 4° C.)” and “life change pattern (spontaneous, forced)” are described. In the “scenario”, a scenario condition in which analysis axes included in the scenario planning target information are combined is described. In the example illustrated in FIG. 4, “1.5°C.×spontaneous, 1.5° C.×forced, 4° C.×spontaneous, 4° C.×forced” is described. In the “analysis target”, an index to be analyzed included in the scenario planning target information is described. In the example illustrated in FIG. 4, “risk” is described. An output 21 illustrated in FIG. 4 is a scenario plan indicating an analysis result of a risk in each scenario described in the prompt 11.

### Specific Example of Scenario Content Generation

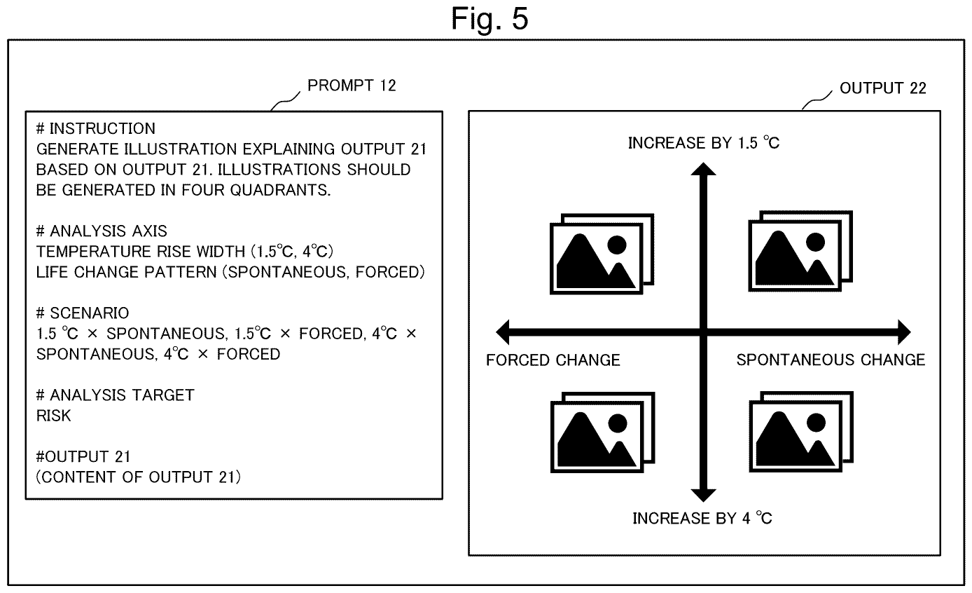

Next, an example of a prompt that is an input of a second model used by the scenario content generation control unit 140 and a scenario content that is an output of the second model will be described with reference to FIG. 5. FIG. 5 is a diagram illustrating a prompt 12 that is an input of the second model used by the scenario content generation control unit 140 and an output 22 that is an output of a second generative model.

As illustrated in FIG. 5, the prompt 12 includes a section indicating a content of the output 21 in addition to the sections of the prompt 11 described with reference to FIG. 4. In the “instruction”, an instruction sentence for generating a scenario content is described in a natural language. In the example illustrated in FIG. 5, an instruction sentence for generating a scenario content in which an illustration for describing a scenario plan (output 21) generated by the scenario plan generation control unit 130 is divided into four quadrants is described in a natural language. The “analysis axis”, the “scenario”, and the “analysis target” are similar to the content of the prompt 11 illustrated in FIG. 4. In addition, the output 22 illustrated in FIG. 5 is a scenario content generated in response to the instruction of the prompt 12.

### First Modification

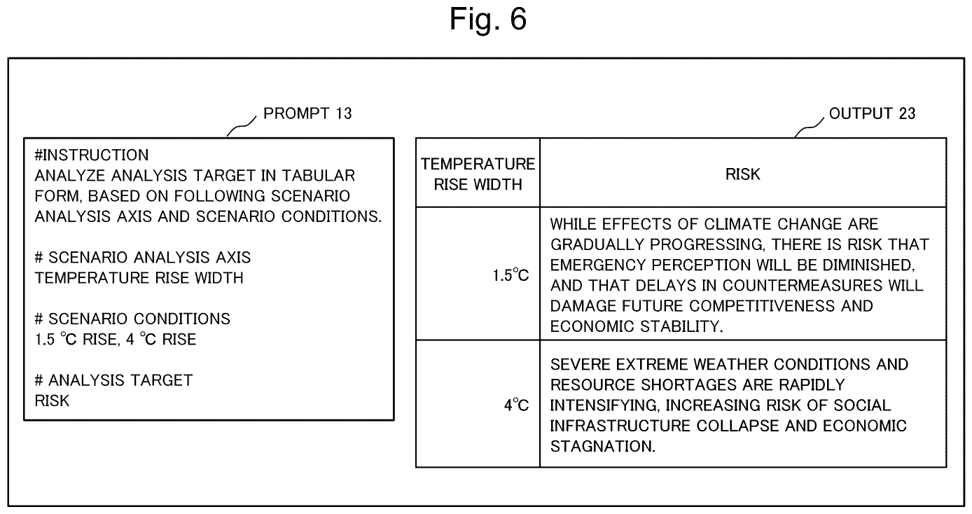

In the first example embodiment, the scenario plan generation control unit 130 generates a scenario plan using one prompt generated by the prompt generation unit 120, but is not limited to this configuration. Hereinafter, as a modification, an example embodiment in which the scenario plan generation control unit 130 generates a final scenario plan from a prompt including a scenario plan generated using a plurality of prompts will be described with reference to FIGS. 6, 7, and 8.

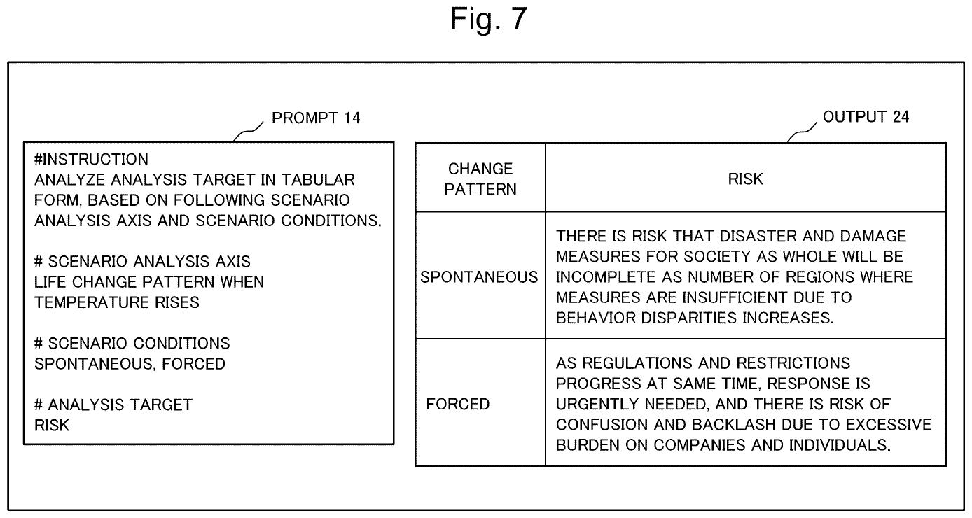

FIGS. 6 and 7 are diagrams illustrating prompts 13 and 14 with one “analysis axis”, and outputs 23 and 24 of first generative models using the respective prompts. The “analysis axis” of the prompt 13 illustrated in FIG. 6 is a “temperature rise width”, and the “analysis axis” of the prompt 14 illustrated in FIG. 7 is a “life change pattern during temperature rise”.

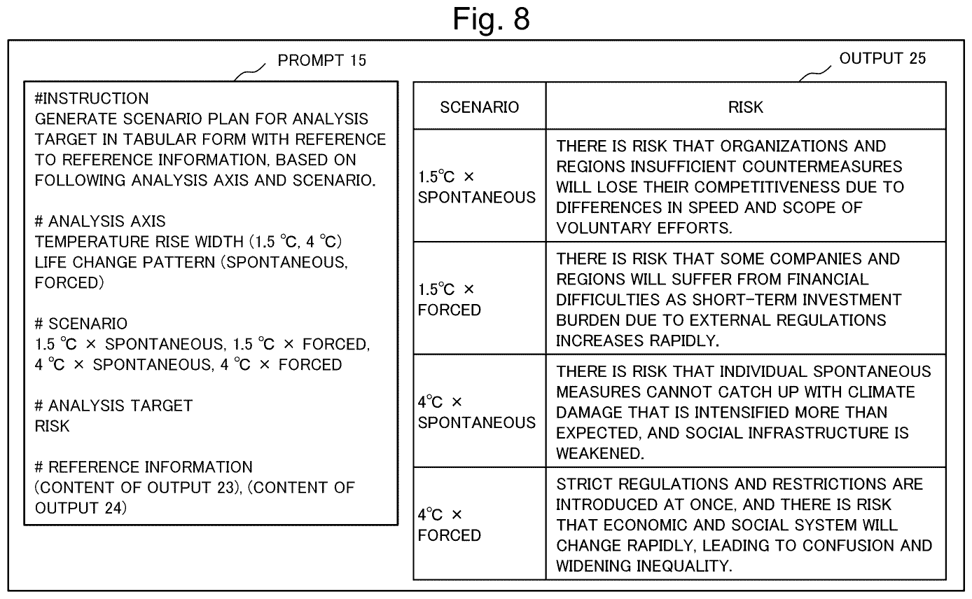

FIG. 8 is a diagram illustrating a prompt 15 including the outputs 23 and 24 illustrated in FIGS. 6 and 7 and an output 25 of the first generative model using the prompt 15. The “analysis axis” of the prompt 15 illustrated in FIG. 8 is the “temperature rise width” and the “life change pattern during temperature rise” which are the “analysis axes” of the prompt 13 in FIG. 6 and the prompt 14 in FIG. 7, respectively. Furthermore, in “reference information” of the prompt 15, a content of the output 23 of FIG. 6 and a content of the output 24 of FIG. 7 are described. That is, the prompt generation unit 120 generates the prompts illustrated in FIGS. 6 and 7, and further generates the prompt illustrated in FIG. 8, including the output generated by the first generative model by using the prompts. The scenario plan generation control unit 130 generates a scenario plan to be finally output to the scenario content generation control unit 140 by using the prompt generated by the prompt generation unit 120 and illustrated in FIG. 8.

As described above, in the first modification, a scenario plan is generated in a stepwise manner using a plurality of prompts, and thus there is an effect that a more accurate scenario plan is generated as compared with a case where a scenario plan is generated using one prompt. The prompt generation unit 120 may similarly generate a prompt to be output to the scenario content generation control unit 140. The present modification is also applicable to a second example embodiment to be described later.

### Second Example Embodiment

The second example embodiment, which is an example of the example embodiments of the present invention, will be described in detail with reference to the drawings. Components having the same functions as the components described in the first example embodiment described above are denoted by the same reference signs, and descriptions thereof will be omitted as appropriate. An application range of each of techniques adopted in the present example embodiment is not limited to the present example embodiment. That is, each technique adopted in the present example embodiment can also be adopted in another example embodiment included in the present disclosure within a range in which no particular technical problem occurs. Each technology illustrated in each of the drawings referred to for describing the present example embodiment can also be adopted in another example embodiment included in the present disclosure within a range in which no particular technical problem occurs.

### Configuration of Scenario Planning Device 100A

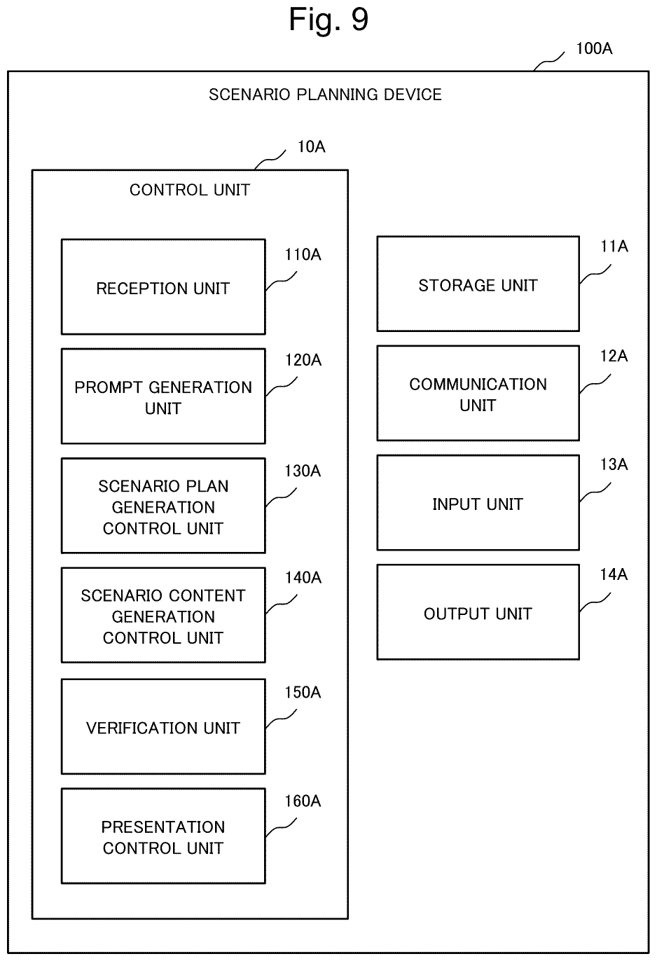

A configuration of a scenario planning device 100A according to the second example embodiment will be described with reference to FIG. 9. FIG. 9 is a block diagram illustrating the configuration of the scenario planning device 100A. The scenario planning device 100A is a device having a scenario planning function of generating a scenario plan. The scenario planning device 100A may be a local device used by an individual user, or may be a server that provides a scenario planning service to a plurality of users.

As illustrated in FIG. 9, the scenario planning device 100A includes a control unit 10A that integrally controls each unit of the scenario planning device 100A, and a storage unit 11A that stores various pieces of data used by the scenario planning device 100A. The scenario planning device 100A includes a communication unit 12A for the scenario planning device 100A to communicate with another device, an input unit 13A that receives an input to an information processing device 1A, and an output unit 14A for the scenario planning device 100A to output data. The control unit 10A includes a reception unit 110A, a prompt generation unit 120A, a scenario plan generation control unit 130A, a scenario content generation control unit 140A, a verification unit 150A, and a presentation control unit 160A.

The reception unit 110A, the prompt generation unit 120A, the scenario plan generation control unit 130A, and the scenario content generation control unit 140A have the same configurations as the reception unit 110, the prompt generation unit 120, the scenario plan generation control unit 130, and the scenario content generation control unit 140 in the first example embodiment, respectively, and description thereof is omitted.

The verification unit 150A verifies whether the content of a scenario plan generated by the scenario plan generation control unit 130A satisfies predetermined criteria, and outputs a verification result to the presentation control unit 160A. Specifically, for example, the verification unit 150A verifies whether the content of the scenario plan satisfies a preset rule as predetermined criteria. The preset rule indicates, for example, whether a list of predetermined keywords (discriminatory expression, potentially misleading language, legally questionable language, and the like) is not included in the scenario plan.

For example, the verification unit 150A may verify whether the content of the scenario plan satisfies predetermined criteria by using a machine learning model. The machine learning model may be a model learned to use the content of the scenario plan as an input and output a determination result regarding whether the predetermined criteria are satisfied. The machine learning model may be any LLM, and the LLM may refer to an external database including a media content, laws, and rules with guaranteed accuracy. The verification unit 150A may verify whether the content of the scenario plan is appropriate by comparing the media content stored in the external database with the scenario plan, calculating an index indicating whether the scenario plan is based on the media content, and determining whether the calculated index satisfies the predetermined criteria. The verification unit 150A may extract a part of the external data referred to in the determination. The rule, the keyword list, and the machine learning model used by the verification unit 150A may be stored in the scenario planning device 100A or may be stored in another device.

The presentation control unit 160A controls the presentation of the scenario plan generated by the scenario plan generation control unit 130A, based on the verification result input from the verification unit 150A. The “presentation” means that a user (for example, a person who has designated an analysis target) can recognize a presentation content. Specifically, for example, in the case of a verification result indicating that the scenario plan satisfies the predetermined criteria, the presentation control unit 160A displays the scenario plan on a display device. Thereby, the user can recognize the scenario plan displayed on the display device. For example, the presentation control unit 160A may perform control to upload the scenario plan to a server accessible by the user. Thereby, the user can access the server and recognize the scenario plan uploaded by the presentation control unit 160A.

In the case of a verification result indicating that the scenario plan satisfies the predetermined criteria, the presentation control unit 160A may perform control to present the scenario content generated by the scenario content generation control unit 140A. A presentation mode of the scenario content is similar to a presentation method for the scenario plan. When the verification unit 150A mentioned above verifies the content of the scenario content, the presentation control unit 160A may control the presentation of the scenario content, based on the verification result input from the verification unit 150A.

As described above, in the scenario planning device 100A according to the second example embodiment, a configuration is adopted in which the reception unit 110A that receives scenario planning target information, the prompt generation unit 120A that generates a prompt based on the scenario planning target information, the scenario plan generation control unit 130A that generates a scenario plan by inputting the prompt to a first generative model that refers to a database including at least data regarding a media content, and the scenario content generation control unit 140A that generates a scenario content by inputting the scenario planning target information to a second generative model. Therefore, similarly to the scenario planning device 100A, it is possible to obtain an effect that a content related to a scenario plan can be generated.

The scenario planning device 100A includes the verification unit 150A that verifies whether the content of the scenario plan generated by the scenario plan generation control unit 130A is appropriate. Further, the scenario planning device 100A includes the presentation control unit 160A that presents one or more of the scenario plans verified by the verification unit 150A to satisfy the predetermined criteria and the scenario content generated based on the scenario plan. Thereby, in addition to the effect obtained by the scenario planning device 100 described in the first example embodiment, it is possible to obtain an effect that only scenario planning and a scenario content satisfying predetermined criteria can be presented.

### Flow of Process

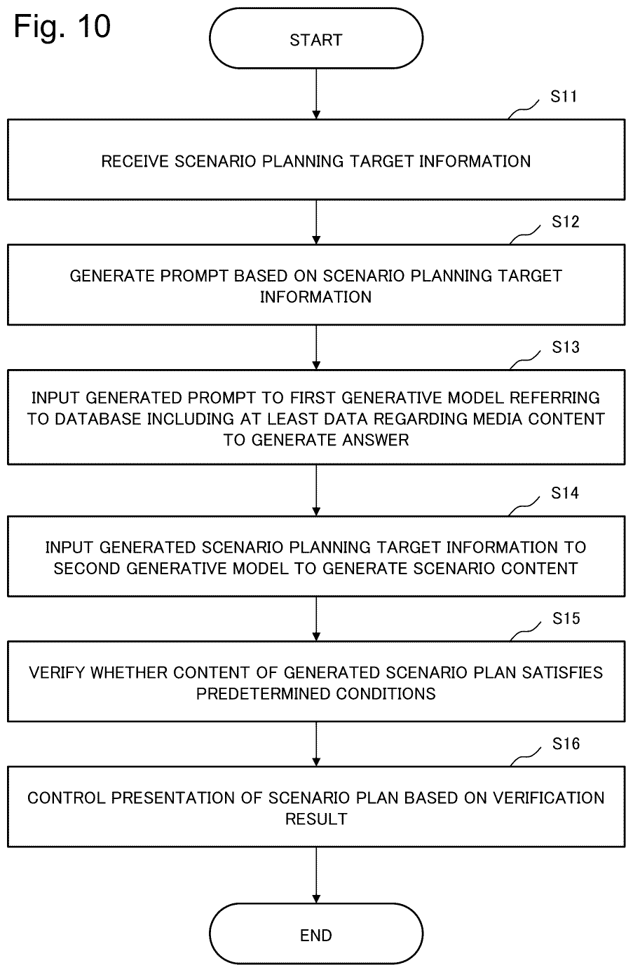

A flow of a scenario planning method according to the second example embodiment will be described with reference to FIG. 10. FIG. 10 is a flowchart showing a flow of a scenario planning method. An execution subject of each step in the scenario planning method may be a processor included in the scenario planning device 100A, may be a processor included in another device, or may be a processor provided in a device in which execution subjects of respective steps are different from each other.

In S11 (reception process), at least one processor receives scenario planning target information.

In S12 (prompt generation process), at least one processor generates a prompt based on the scenario planning target information received in S11.

In S13 (scenario plan generation control process), at least one processor inputs the prompt generated in S12 to the first generative model that refers to a database including at least data regarding a media content to generate an answer.

In S14 (scenario content generation control process), at least one processor inputs scenario planning information generated in S13 to the second generative model to generate a scenario content.

In S15 (verification process), at least one processor verifies whether the content of the scenario plan generated in S14 satisfies predetermined conditions.

In S16 (presentation control process), at least one processor controls the presentation of the scenario plan generated in S13 based on the verification result in S15.

As described above, a configuration is adopted in which the scenario planning method according to the second example embodiment includes a reception process of receiving scenario planning target information, a prompt generation process of generating a prompt based on the scenario planning target information, a scenario plan generation control process of generating a scenario plan by inputting the prompt to a first generative model that refers to a database including at least data regarding a media content, a scenario content generation control process of generating a scenario content by inputting the scenario planning target information to a second generative model, a verification process of verifying whether the content of the scenario plan satisfies predetermined conditions, and a presentation control process of controlling the presentation of the scenario plan generated by the scenario plan generation control process, based on the verification result of the verification process. Thereby, in addition to the effects achieved by the first example embodiment, it is possible to obtain an effect of reducing the possibility that scenario planning and a scenario content different from the fact are presented.

An execution entity of each process described in the second example embodiment described above is any entity and is not limited to the above-described examples. For example, a system having a function similar to that of the scenario planning device 100A can be constructed by a plurality of devices capable of communicating with each other. An execution subject of each processing illustrated in the flowchart shown in FIG. 10 may be one device (also referred to as a processor) or a plurality of devices (also referred to as a processor).

### Modification of Second Example Embodiment

Hereinafter, an embodiment of each component that reflects a feedback (for example, a correction request or a request for additional information) from a user in a scenario plan or a scenario content presented by the presentation control unit 160A will be described as a modification of the second example embodiment. Specifically, for example, the reception unit 110A receives a feedback of a natural language input via an apparatus used by the user, and outputs the feedback to the prompt generation unit 120A. The prompt generation unit 120A generates a prompt reflecting the correction request and the request for additional information indicated by the feedback input from the reception unit 110A by using a language model that has learned a natural language. For example, the prompt generation unit 120A generates a prompt in which the content of the “scenario condition” section is corrected, an “analysis axis” is added, and the like.

The scenario plan generation control unit 130A generates a scenario plan reflecting the feedback by using the prompt newly generated by the prompt generation unit 120A. The scenario content generation control unit 140A generates a scenario content reflecting the feedback by using the scenario plan newly generated by the scenario plan generation control unit 130A. The prompt generation unit 120A may generate a prompt based on the scenario plan reflecting the feedback and output the generated prompt to the scenario content generation control unit 140A, similar to the case described in the first example embodiment.

Furthermore, when the feedback is only for a scenario content (for example, “keep the scenario plan unchanged and make the content simpler”), the prompt generation unit 120A generates, for example, a prompt in which the content of an “instruction” is corrected. In this case, the prompt generation unit 120A outputs the generated prompt to the scenario content generation control unit 140A. Thereby, only the scenario content is corrected by reflecting the feedback.

This feedback function makes it possible to perform interactive use between the user and the system and to gain deeper insights. The output accuracy of the scenario planning device is continuously improved, and an effect of generating scenario planning more appropriate for the needs of the user is achieved.

### Example of Achievement by Software

Some or all of the functions of the scenario planning devices 100 and 100A (hereinafter, also referred to as “each of the above devices”) may be implemented by hardware such as an integrated circuit (IC chip) or by software.

### Hardware Configuration

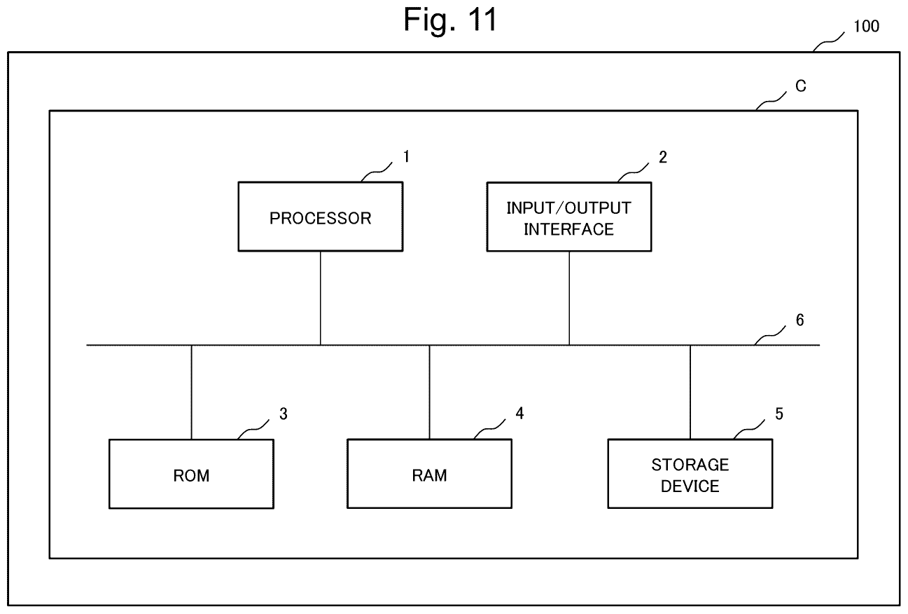

In the latter case, each of the above devices is implemented by, for example, a computer C that executes commands of a program, that is software for implementing each function. FIG. 11 is a block diagram illustrating a hardware configuration of the scenario planning device 100. As illustrated in the drawing, the scenario planning device 100 includes a processor 1, an input/output interface 2, a read only memory (ROM) 3, a random access memory (RAM) 4, and a storage device 5. The components are connected to each other via, for example, a bus 6.

The processor 1 is an arithmetic device such as a central processing unit (CPU), and controls the entire scenario planning device 100 by executing a program prepared in advance. Specifically, it is possible to use, as the processor 1, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, a combination thereof, or the like.

The processor 1 loads programs stored in the ROM 3, the storage device 5, and the like. Then, the processor 1 executes each process coded in the program. The processor 1 functions as a part or the entirety of the scenario planning device 100. The processor 1 may execute processes or commands in the flowchart based on the programs.

The input/output interface 2 is an interface for connecting input/output devices such as a keyboard, a mouse, a display, and a printer.

The ROM 3 stores various programs executed by the processor 1. The RAM 4 is used as a working memory during execution of various processes by the processor 1.

The storage device 5 is a non-volatile non-transitory storage device. For example, the storage device 5 may be a disk-like recording medium, a semiconductor memory, or the like. The storage device 5 may be configured to be detachable from the scenario planning device 100. The storage device 5 records various programs executed by the processor 1. A machine learning model, learning data, and the like may be stored.

The each function of the above devices may be implemented by a single processor provided in a single computer, may be implemented by a plurality of processors, which are provided in a single computer, in cooperation, or may be implemented by a plurality of processors, which are provided in a plurality of computers, in cooperation. The program for causing each of the above devices to achieve each of the above functions may be stored in a single memory provided in a single computer, may be stored in a distributed manner in a plurality of memories provided in a single computer, or may be stored in a distributed manner in a plurality of memories provided in each of a plurality of computers.

Some or all of the example embodiments described above may also be described as the following Supplementary Notes, but are not limited to the following.

### Supplementary Note 1

A scenario planning device including:
a reception unit configured to receive scenario planning target information;
a scenario plan generation control unit configured to generate a scenario plan, based on the scenario planning target information and a first generative model; and
a scenario content generation control unit configured to generate a scenario content for visualizing the scenario plan, based on the scenario plan and a second generative model.

### Supplementary Note 2

The scenario planning device according to supplementary note 1, further including
a prompt generation unit configured to generate a prompt to be input to the first generative model.

### Supplementary Note 3

The scenario planning device according to Supplementary Note 2, wherein
the prompt generation unit
generates a first prompt to be input to the first generative model based on the scenario planning target information, and
the scenario plan generation control unit
inputs the first prompt to the first generative model to generate a scenario plan.

### Supplementary Note 4

The scenario planning device according to Supplementary Note 2 or 3, wherein
the prompt generation unit
further generates a second prompt to be input to the second generative model, based on the scenario plan, and
the scenario content generation control unit
inputs the second prompt to the second generative model to generate a scenario plan.

### Supplementary Note 5

The scenario planning device according to Supplementary Note 1, wherein
the first generative model
refers to a database including at least data regarding a media content.

### Supplementary Note 6

The scenario planning device according to Supplementary Note 1, wherein
the first generative model is
a generative model that is machine-learned to output a scenario plan for an input prompt, and
the second generative model is
a generative model that is machine-learned to output a scenario content for an input scenario plan.

### Supplementary Note 7

The scenario planning device according to Supplementary Note 6, further including:
a verification unit configured to verify whether a content of the scenario plan satisfies predetermined criteria; and
a presentation control unit configured to present the scenario plan when the verification unit verifies that the scenario plan satisfies the predetermined criteria.

### Supplementary Note 8

The scenario planning device according to Supplementary Note 7, further including
a prompt generation unit configured to generate a prompt to be input to the first generative model, wherein
the reception unit receives a feedback for the scenario plan presented by the presentation control unit, and
the prompt generation unit generates a new prompt including a correction instruction based on the feedback.

### Supplementary Note 9

A scenario planning method including causing at least one processor to:
receive scenario planning target information;
generate a scenario plan, based on the scenario planning target information and a first generative model; and
generate a scenario content for visualizing the scenario plan, based on the scenario plan and a second generative model.

### Supplementary Note 10

A scenario planning program causing a computer to function as:
a reception means for receiving scenario planning target information;
a scenario plan generation control means for generating a scenario plan, based on the scenario planning target information and a first generative model; and
a scenario content generation control means for generating a scenario content for visualizing the scenario plan, based on the scenario plan and a second generative model.

Some or all of the configurations described in Supplementary Notes 2 to 8 dependent on the above-described Supplementary Note 1 can also be dependent on each of Supplementary Notes 9 and 10 by similar dependency relationship to Supplementary Notes 2 to 8. Further, the present invention is not limited to Supplementary Notes 1, 9, and 10, some or all of the configurations described as the supplementary notes can be similarly dependent on various pieces of hardware and software, various types of recording means for recording software, or systems without departing from the example embodiments described above.

1. A scenario planning device comprising:
a memory configured to store instructions; and
one or more processors configured to execute the instructions to:
receive scenario planning target information;
generate a scenario plan, based on the scenario planning target information and a first generative model; and
generate a scenario content for visualizing the scenario plan, based on the scenario plan and a second generative model.

2. The scenario planning device according to claim 1, wherein
the one or more processors are further configured to execute the instructions to:
generate a prompt to be input to the first generative model.

3. The scenario planning device according to claim 2, wherein
the one or more processors are further configured to execute the instructions to:
generate a first prompt to be input to the first generative model based on the scenario planning target information; and
input the first prompt to the first generative model to generate a scenario plan.

4. The scenario planning device according to claim 2, wherein
the one or more processors are further configured to execute the instructions to:
generate a second prompt to be input to the second generative model, based on the scenario plan; and
input the second prompt to the second generative model to generate a scenario content.

5. The scenario planning device according to claim 1, wherein
the first generative model refers to a database including at least data regarding a media content.

6. The scenario planning device according to claim 1, wherein
the first generative model is a generative model that is machine-learned to output a scenario plan for an input prompt, and
the second generative model is a generative model that is machine-learned to output a scenario content for an input scenario plan.

7. The scenario planning device according to claim 6, wherein
the one or more processors are further configured to execute the instructions to:
verify whether a content of the scenario plan satisfies predetermined criteria; and
present the scenario plan in case that the scenario plan satisfies the predetermined criteria.

8. The scenario planning device according to claim 7, wherein
the one or more processors are further configured to execute the instructions to:
receive a feedback for the presented scenario plan presented; and
generate a prompt to be input the first generative model based on the feedback.

9. A scenario planning method comprising:
receiving scenario planning target information;
generating a scenario plan, based on the scenario planning target information and a first generative model; and
generating a scenario content for visualizing the scenario plan, based on the scenario plan and a second generative model.

10. A non-transitory computer-readable recording medium storing a scenario planning program causing a computer to execute a method, the method comprising:
receiving scenario planning target information;
generating a scenario plan, based on the scenario planning target information and a first generative model; and
generating a scenario content for visualizing the scenario plan, based on the scenario plan and a second generative model.
